(19) United States
(12) Patent Application Publication
(10) Pub. No.: US 2005/0141923 A1
(43) Pub. Date: Jun. 30, 2005

(54) Image forming apparatus

(75) Inventor: Mitsuhiro Ota, Toride-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/014,770

(22) Filed: Dec. 20, 2004

(30) Foreign Application Priority Data
Dec. 26, 2003 (JP) 2003-435690

(51) Int. Cl. G03G 15/02; G03G 21/00

(52) U.S. Cl. 399/175; 399/350

(57) ABSTRACT

The present invention extends the lives of a photosensitive drum and a cleaning blade. A magnetic brush charging device is excellent in charging performance, and is effective to realize being ozoneless and the smoothing of the photosensitive drum, and the removal of a fused material therefrom. However, due to the smoothing action, a lubricant such as a toner decreases between the photosensitive drum and the edge portion of the cleaning blade, whereby the frictional force of the edge portion is increased and scraping-through by chattering of the toner becomes great. So, inorganic fine particles having the lubricating action are contained in at least the edge portion. Thereby, the hardness of the edge portion crises and the property thereof following the unevenness of the surface of the photosensitive drum is lowered, but the surface of the photosensitive drum is smooth and therefore, sufficient cleaning performance can be secured.

### BACKGROUND OF THE INVENTION

1. Field of the Invention

This invention relates to an image forming apparatus for forming an image by the use of an electrophotographic process, and particularly to an image forming apparatus such as a copying machine, a printer or a facsimile apparatus.

2. Related Background Art

1. Image Forming Apparatus

An image forming apparatus such as a copying machine or a laser beam printer utilizing an electrophotographic process is basically provided with an electrophotographic photosensitive member (photosensitive member) usually of a rotary drum type as a first image bearing member, charging means (charging device) for uniformly charging the surface of this photosensitive member to a predetermined polarity and potential, image exposing means (exposing apparatus) for forming an electrostatic latent image on the charged surface of the photosensitive member, developing means (developing apparatus) for developing the electrostatic latent image as a toner image, transferring means (transfer charging device) for transferring the toner image from the surface of the photosensitive member to a recording material as a second image bearing member (recording medium), fixing means (fixing device) for fixing the toner image transferred to the recording material as a permanent fixed image, and cleaning means (cleaning apparatus) for removing any residual toner on the surface of the photosensitive member after the transfer of the toner image to the recording material to thereby clean the surface of the photosensitive member. The recording material subjected to the fixing process by the fixing device is discharged as an image-formed article (a copy or a print). The photosensitive member cleaned by the cleaning apparatus is repetitively used for image forming.

2. Contact Charging Means

A corona charging device has heretofore been used as a charging device for uniformly charging the surface of the photosensitive member to a predetermined polarity and potential. The corona charging device is disposed in non-contact and opposed relationship with the surface of the photosensitive member (member to be charged), and exposes the surface of the photosensitive member to a corona shower produced when a high voltage is applied, to thereby charge the surface of the photosensitive member to a predetermined polarity and potential.

In recent years, instead of this, a contact charging apparatus has come into practical use. This applies a predetermined charging bias to an electrically conductive charging member of a roller type (charging roller), a fur brush type, a magnetic brush type, a blade type or like type to thereby charge the surface of the photosensitive member as the member to be charged to a predetermined polarity and potential, and has such advantages as low ozone and low electric power, as compared with the corona charging device.

In such a contact charging apparatus, however, the essential charging mechanism thereof uses a discharging phenomenon from the contact charging member to the photosensitive member and therefore, the voltage applied to the contact charging member is required to be of a value equal to or greater than the surface potential of the photosensitive member, and a minute amount of ozone is produced.

Also, when AC charging is effected for the uniformization of charging, further production of ozone occurs, and the occurrence or the like of the vibration noise (AC charging sound) of the contact charging member and the photosensitive member by the electric field of an AC voltage becomes remarkable, and this has posed a new problem.

(Direct Injection Charging)

A direct injection charging mechanism has been proposed as a mechanism for preventing the occurrence of the vibration noize in the above-described contact charging apparatus. Regarding the direct injection charging mechanism, in the way of advance such as a series of improvements in the contact charging member, Japanese Patent Application Laid-Open No. S59-133569 proposes a mechanism in which a contact charging member of magnetic brush-like particles comprising a magnetic material and magnetic particles (or powder material) contacts with and imparts charges to a photosensitive member.

Further, Japanese Patent Application Laid-Open NO. S57-046265 proposes a new system in which a brush-like contact charging member employing a fur made of conductive fibers contacts with and imparts charges to a photosensitive member.

The contact injection charging does not use the discharging phenomenon and therefore, a voltage required for charging is that only for the desired surface potential of the photosensitive member. Accordingly, this is an ozoneless and low electric power charging method free of the occurrence of ozone. Also, charges are directly injected and therefore, the surface potential is equivalent to the applied voltage, and a charging start voltage Vth does not appear. Therefore, even when a DC voltage is applied, it is not varied for the fluctuation of the environment such as humidity, and stable charging becomes possible.

On the other hand, from the characteristic that charges are injected only to an area in which the charging member contacts with the surface of the photosensitive member, the probability of contact between the charging member and the surface of the photosensitive member governs the charging capability. If the probability of contact is low (the contact is insufficient) and there are many uncharged areas, charging ends before the surface potential of the photosensitive member reaches the voltage applied to the charging device. As a charging method which can uniformly obtain high probability of contact mention may be made of magnetic brush charging and a method of causing electrically conductive fine particles to adhere to an electrically conductive elastic roller, and charging the surface of the elastic roller and the photosensitive member with the fine particles interposed therebetween. The former magnetically restrains electrically conductive magnetic particles on the surface of a sleeve (developing roller) generally containing a magnet roller therein, and rotates the sleeve to thereby effect charging while enhancing the probability of contact thereof with the surface of the photosensitive member.

The latter causes electrically conductive fine particles to adhere onto a sponge roller formed of an electrically conductive sponge or the like, and causing the particles to intervene between the sponge roller and the surface of the photosensitive member to thereby decrease the frictional resistance thereof with the photosensitive member and make it possible to provide a speed difference between the roller and the photosensitive member, and improve the probability of contact thereof with the photosensitive member by the speed difference and the intervention of the particles.

3. Photosensitive Member

(Photosensitive Member of Amorphous Silicon (a-Si) Origin)

In an electrophotographic apparatus, a photoconductive material forming the photosensitive layer of the photosensitive member is required to have such characteristics that it has high sensitivity and a high SN ratio [photocurrent (Ip)/dark current (Id)] and has an absorption spectrum fit for the spectral characteristic of an applied electromagnetic wave, that it is quick in response to light and has a desired dark resistance value, and that during use, it is harmless to the human body. Particularly, in the case of a photosensitive member for an electrophotographic apparatus incorporated into an electrophotographic apparatus used as an office machine in an office, considering that it is used for copying in a great deal and for a long period of time, the long-term stability of the quality of image and image density is also an important point.

As a photoconductive material which exhibits an excellent property in such points, there is amorphous silicon hydride (hereinafter referred to as a-si:H), and the application thereof as a photosensitive member for an electrophotographic apparatus is described, for example, in Japanese Patent Publication No. S60-35059.

To obtain such a photosensitive member for an electrophotographic apparatus, generally an electrically conductive supporting member is heated to 50 to 400° C., and on this electrically conductive supporting member, a photoconductive layer comprising a-Si is formed by a film forming method such as a vacuum vapor deposition method, a sputtering method, an ion plating method, a heat CD method, an optical CD method or a plasma CD method. Above all, the plasma CD method, i.e., a method of decomposing a raw material gas by DC or high frequency or micro-wave glow discharge to thereby form a-Si piled film is put into practical use as a suitable method.

By these techniques, the electrical, optical and photoelectrical characteristics and use-environmental characteristic of the photosensitive member for the electrophotographic apparatus have been improved and along therewith, the quality of image has also been improved.

The amorphous silicon photosensitive member also exhibits good chargeability for the injection charging process.

4. Cleaning Means

As a cleaning member (residual toner cleaning means) for removing any toner residual on the surface of the photosensitive member from the surface of the photosensitive member, a cleaning blade formed of an elastic material such as urethane rubber has heretofore been widely practically used because of its simple and compact construction and its advantage in cost.

Many of such cleaning blades are adapted to have their edge portions brought into pressure contact with the surface of the moved photosensitive member with the rotation of the photosensitive member from such a direction (counter direction) as opposes the direction of movement thereof. Therefore, a great frictional force is produced on the edge portion between it and the photosensitive member.

Some residual toner, however, exists on the image area of the surface of the photosensitive member and therefore, although the cleaning blade originally acts to scrape off this toner, conversely the presence of this toner acts as a lubricant on the portion of contact between the surface of the photosensitive member and the edge portion, and the two maintains their initial relative positional relation and acts to remove the toner.

However, under a certain condition, for example, in a case where originals extremely low in image density have been continuously printed, the supply of the toner which provides the lubricating action between the cleaning blade and the photosensitive member has been cut off and the coefficient of friction has become extremely great, and the fore end portion of the cleaning blade has been reversed so as to be along the direction of movement of he surface of the photosensitive member (the so-called the turning-up of the blade), and the damage of the fore end edge has partly occurred. Also, even in the case of a user who takes many images of a high duty (images having a large area of image portion), the photosensitive member causes ozone deterioration due to endurance, or adhering substances such as the toner, an extraneous additive and the talc of paper occur on the surface of the photosensitive member, whereby filming film is formed and therefore, there arises the evil that the slipperiness between the surface of the photosensitive member and the cleaning blade is lost.

From the recent demand for being maintenance-free, as the toner, use is made of a polymeric toner having wax contained therein, i.e., a toner of a construction in which wax is dispersed in the form of sea islands. By wax being inwardly added to the toner, fixing oil heretofore supplied to the fixing roller (fixing member) of the fixing apparatus, such as, for example, dimethyl silicone or amino denatured silicone oil becomes unnecessary and the construction of the fixing apparatus is simplified. Further, the material usable for the fixing member is not limited to a rubber material, but a fluorine resin material also becomes usable and thus, a longer life of the fixing member can be achieved, and this greatly contributes to being maintenance-free.

On the other hand, when wax is inwardly added, the wax comes to exist on the surface of the toner and therefore, aggregation between the toners becomes liable to occur from the mutual affinity of the wax. Generally it becomes difficult to remove the residual toner which is high in the degree of aggregation. If the degree of aggregation is high, the fluidity of the toner lowers and for example, the supply of an extraneous additive acting as a lubricant to the vicinity of the nip of the cleaning blade cannot be sufficiently effected, and the frictional force between the cleaning blade and the surface of the photosensitive member increases, and the scraping-through of the toner due to the cleaning blade chattering occurs.

In perfectly using a toner to which the wax has been inwardly added, it becomes one of great tasks to remove the toner well from the surface of the photosensitive member.

So, in order to secure the slipperiness between the cleaning blade and the surface of the photosensitive member on the cleaning blade side so that good cleaning can be effected even if the toner supply amount to the cleaning blade is small, and even if filming film occurs on the photosensitive member and further, even when the degree of aggregation of the toner is high, there has been adopted a method of coating the cleaning blade with nylon or other resin having carbon fluoride dispersed therein to thereby highly harden the edge portion, or causing a lubricant to be contained in the edge portion.

However, the cleaning blade coated with resin such as nylon or the edge portion caused to contain a lubricant has suffered from the problem that the edge portion becomes a resin quality and elasticity becomes small or the uniformity of the edge ridge line in a thrust direction lacks, and the affinity of rubber such as polyurethane with the drum is taken away and a nip cannot be formed well, whereby particularly when the surface of the photosensitive member is roughened, the toner cannot be uniformly intercepted in a longitudinal direction and the scraping-through of the toner is liable to occur.

In order to avoid this, it has been necessary to make the abutting pressure and the amount of entry of the blade high as compared with those of a conventional urethane rubber blade.

However, when the blade pressure is high, the deterioration of the blade itself during the endurance thereof and the edge breakage or the damage to the photosensitive member when a foreign substance has entered the edge portion pose a problem.

On the other hand, when the a-Si drum which is very uneven in dark attenuation, as compared with a heretofore existing organic photosensitive member, is used in a machine of a high quality of image such as a color machine, uneven charging potential is a great problem. To avoid this unevenness, there is adopted a magnetic brush charging process of a direct injection charging type or the like.

Such a charging process has great merits such as the elimination of uneven potential and the elimination of ozone, but it also has the effect of polishing the photosensitive member and therefore tends to smooth the surface of the photosensitive member.

When the surface of the photosensitive member is thus smoothed, it has been difficult for the conventional cleaning blade to display sufficient cleaning performance.

### SUMMARY OF THE INVENTION

It is an object of the present invention to provide an image forming apparatus in which an image bearing member can be cleaned well even if the image forming apparatus is of a construction in which electrically conductive fine particles are rubbed to thereby effect the charging of the image bearing member.

It is another object of the present invention to provide an image forming apparatus which can satisfy both of the uniformity of the charging of an image bearing member by charging means and the cleanability of the image bearing member by a blade.

It is still another object of the present invention to provide an image forming apparatus comprising:
an image bearing member;
image forming means for forming a toner image on the image bearing member, the image forming means having charging means for charging the image bearing member by rubbing electrically conductive fine particles against the image bearing member; and
an elastic blade for removing residual toner on the image bearing member;
wherein the edge portion of the blade which abuts against the image bearing member is low-friction-processed.

Further objects of the present invention will become apparent from the following detailed description when read with reference to the accompanying drawings.

### BRIEF DESCRIPTION OF THE DRAWINGS

FIG. 1 schematically shows the construction of an image forming apparatus according to the present invention.

FIG. 2 shows the relation between the duration number and the surface roughness of a photosensitive drum.

FIG. 3 is an enlarged view typically showing the construction of a cleaning apparatus.

FIGS. 4A and 4B illustrate the differences in cleaning performance depending on the kinds of a cleaning blade in a first embodiment.

FIGS. 5A and 5B illustrate the differences in cleaning performance depending on the kinds of a cleaning blade in a second embodiment.

FIG. 6 illustrates a method of manufacturing the cleaning blade in the second embodiment.

### DETAILED DESCRIPTION OF THE PREFERRED EMBODIMENTS

Some embodiments of the present invention will hereinafter be described with reference to the drawings. Throughout the drawings, members given the same reference characters are similar in construction or action, and the duplicate description of these is suitably omitted.

### First Embodiment

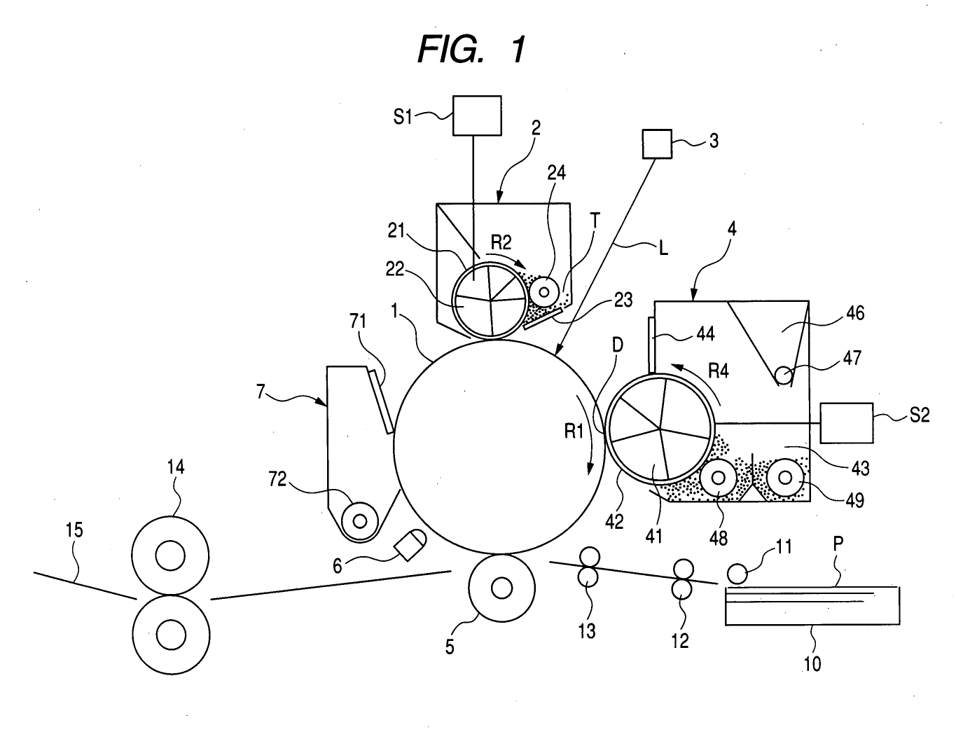

FIG. 1 shows an image forming apparatus according to a first embodiment as an example of an image forming apparatus according to the present invention. The image forming apparatus shown in FIG. 1 is a printer of an electrophotographic type, and FIG. 1 is a longitudinal cross-sectional view schematically showing the construction thereof.

The printer (hereinafter referred to as the “image forming apparatus”) shown in FIG. 1 is provided with a drum-shaped electrophotographic member (hereinafter referred to as the “photosensitive drum”) as an image bearing member. The photosensitive drum 1 is rotatably supported by an image forming apparatus main body (not shown) and is adapted to be rotatively driven in the direction of arrow R1 by driving means (not shown).

Around the photosensitive drum 1, substantially in succession along the direction of rotation thereof, there are disposed a charging device (charging means) 2 for uniformly charging the surface of the photosensitive drum 1 to a predetermined polarity and potential, an exposing apparatus (exposing means) 3 as latent image forming means for exposing the surface of the photosensitive drum 1 after charged to light in conformity with image information to thereby form an electrostatic latent image thereon, a developing apparatus (developing means) 4 for developing the electrostatic latent image as a toner image with a developer (toner), a transfer roller (transferring means) 5 for transferring the toner image formed on the surface of the photosensitive drum 1 to a recording material P (e.g. sheet-like paper or transparent film), a charge eliminating device 6 for eliminating the charges of the photosensitive drum 1 after the transfer of the toner image, and a cleaning apparatus (cleaning means) 7 for removing any toner (residual toner) not transferred to the recording material P during the transfer but residual on the surface of the photosensitive drum 1.

Also, on an upstream side (the right side in FIG. 1) along the conveying direction (the direction of arrow K in FIG. 1) of the recording material P, there are disposed a sheet supplying cassette 10 containing recording materials P therein, a sheet feeding roller 11 for feeding the recording material P from the sheet supplying cassette 10, conveying rollers 12 for conveying the fed recording material P, registration rollers 13 for temorarily stopping the conveyed recording material P, and thereafter supplying it to a transferring portion N in such a manner as to time the recording material P with the toner image on the photosensitive drum 1, a fixing device 14 for fixing the toner image on the recording material P after the transfer of the toner image, and a sheet discharging tray 15 onto which the recording material P after the fixing is discharged.

In the present embodiment, an amorphous silicon (a-Si) photosensitive member is used as the above-described photosensitive drum 1. As the construction of the a-Si photosensitive member, use is made of a construction in which a lower portion charge injection preventing layer is provided on the outer peripheral surface of an electrically conductive cylindrical drum base (made of e.g. aluminum), and a photosensitive layer is provided thereon. Thereby, the entry of charges from the drum base can be prevented. Further, for an improvement in durability, a surface protecting layer may be provided on the surface of the photosensitive layer, or in order to prevent the injection of latent image charges from the surface of a latent charge image holding member, an upper portion charge injection preventing layer may be provided on the upper portion of the photosensitive layer or between the surface protecting layer and the photosensitive layer. Also, a layer serving as the surface protecting layer and also as the upper portion charge injection preventing layer may be provided on the surface of the photosensitive layer. Further, it is also possible to provide a long wavelength light layer in order to prevent the appearance of the interference phenomenon of long wavelength light.

As the charging device 2 for injection-charging the photosensitive member, use is made of a magnetic brush charging device. The magnetic brush charging device has a rotatable developing roller (developing sleeve) 21 having a diameter of 16 mm, and a magnet roller 22 disposed in a fixed state inside this developing roller 21. The developing roller 21 is disposed so as to be opposed to the surface of the photosensitive drum 1 with an interval of 500 μm therebetween and constitutes a charging portion. A charging bias comprising a DC voltage VD of −600V superimposed on an alternating voltage AC having a peak-to-peak voltage of 500 pp and a frequency of 1 kHz is adapted to be applied from a voltage source S1 to the developing roller 21. The magnet roller 22 is of a repulsion pole construction having five magnetic pole peaks in the direction of rotation of the developing roller 21 and having magnetic pole peaks of the same polarity adjacent thereto. Electrically conductive magnetic particles which are a charging member are held on the developing roller 21 by the magnetic restraining force of the magnet roller 22, and have their layer thickness regulated by a regulating blade 23, and thereafter are adapted to contact with the photosensitive drum 1. Also, the developing roller 21 is driven in the direction of arrow 2 by a motor (not shown), and is rotated at a peripheral speed of 150 mm/sec. The peripheral speed of the developing roller 21, when it is too low, becomes a factor of a faulty image such as uneven charging because the probability of contact between the surface of the photosensitive drum 1 and the magnetic particle becomes low. Conversely, when the aforementioned peripheral speed is too high, it causes the scattering of the magnetic particles. The peripheral speed for which good charging can be effected depends on the outer diameter of the developing roller 21 and the interval between the developing roller 21 and the photosensitive drum 1, but the peripheral speed of the charging sleeve 21 in the present embodiment should preferably be 50 to 250 mm/sec.

As described above, the gap of the nip between the surface of the photosensitive drum 1 and the developing roller 21 in the charging portion is 500 μm and the magnetic flux density on the developing roller 21 in the charging portion by the magnet roller 22 is 950×10⁻⁴ T. A reservoir portion T for the magnetic particles is formed upstream of the regulating blade 23 along the direction of rotation of the developing roller 21, and a screw 24 agitates the magnetic particles in the reservoir portion T in the direction of the generatrix of the surface of the developing roller 21. The screw 24 comprises elliptical vanes alternately mounted in the axial direction thereof, and can agitate the magnetic particles in the reservoir portion T without causing them to be one-sides.

The following can be suitably used as the above-described magnetic particles:
Resin and a magnetic powder material such as magnetite kneaded and shaped into particles, or electrically conductive carbon or the like mixed therewith for the adjustment of a resistance value;
Sintered magnetite or ferrite or these reduced or oxidation-processed to thereby adjust the resistance value thereof; or
The above-described magnetic particles coated with a resistance-adjusted coat material (phenol resin having carbon dispersed therein or the like) or plating-processed with a metal such as Ni and made to have a suitable resistance value, or the like.

If the resistance value of these magnetic particles is too high, charges cannot be uniformly injected into the photosensitive drum 1 and a fogged image due to minute faulty charging is formed. If conversely, the resistance value is too low, when there is a pinhole in the surface of the photosensitive drum 1, an electric current concentrates in the pinhole and the charging voltage drops and the surface of the photosensitive drum cannot be charged, thus resulting in faulty charging in the form of a charging nip. Consequently, the resistance value of the magnetic particles should desirably be 1×10⁻⁴ to 1×10⁷ Ω.

As the magnetic characteristic of the magnetic particles, it is better to make the magnetic restraining force high in order to prevent the adherence of the magnetic particles to the photosensitive drum 1, and saturation magnetization should desirably be equal to or greater than 50 (A·m²/kg).

The magnetic particles actually used in the present embodiment had a volume average particle diameter of 30 μm, apparent density of 2.0 g/cm³, a resistance value of 1×10⁶ Ω and saturation magnetization of 58 A·m²/kg. Also, the particle diameter of the magnetic particles affects charging capability and the uniformity of charging. That is, if the particle diameter is too large, the rate of contact with the photosensitive drum 1 will lower to thereby cause uneven charging. If the particle diameter is small, both of charging ability and the uniformity of charging will be improved, but the magnetic force acting on a particle will be reduced, and the adherence of the particles to the photosensitive drum 1 will become liable to occur. Therefore, 5 to 100 μm is suitably used as the particle diameter of the magnetic particles.

The total amount of the magnetic particles is 200 g, and design is made such that all the magnetic particles are gently agitated by the agitating effect of the screw 24 and the repulsion poles of the magnet roller 22.

The developing apparatus 4 is provided with a rotatable developing roller 42 containing a fixed magnet roller 41 therein. The developing roller 42 applied a developer in a developing container 43 onto the developing roller 42 as a thin layer by a regulating blade 44 and carried it to a developing portion. At this time, the developing roller 42 is driven by a motor (not shown) and rotated at a peripheral speed of 150 mm/sec. in the direction of arrow R4. The developer 45 is a two-component developer, and consists of a negatively charged toner having a diameter of 8 μm and a positively chargeable magnetic carrier having a diameter of 50 μm mixed together at weight toner density of 5%. The toner density is controlled by an optical type toner density sensor (not shown), and the toner in a toner hopper 46 is supplied by a supplying roller 47. The developer 45 in the developing container 43 is uniformly agitated by agitating members 48 and 49. A developing bias comprising a DC voltage VD of −500V superimposed on an alternating electric field (VA) having a peak-to-peak voltage of 2 kVpp and a frequency of 2 kHz is applied from a voltage source S2 to the developing roller 42. The developer applied as a thin layer and carried to the developing portion D in which the developing roller 42 and the photosensitive drum 1 are opposed to each other is caused to adhere to the electrostatic latent image on the photosensitive drum 1 by an electric field by the above-described developing bias and develops this latent image as a toner image.

The image forming process by the above-described image forming apparatus will now be briefly described with reference to FIG. 1. The photosensitive drum 1 is uniformly charged by the charging device (magnetic brush charging device) 2. A laser beam L of a emitted light wavelength 680 nm corresponding to an image signal is applied to the uniformly charged surface of the photosensitive drum 1 by the exposing apparatus 3. As regards the potential on the photosensitive drum 1, the potential of a portion to which the laser beam L has been applied falls, and an electrostatic latent image is formed. That portion of the electrostatic latent image to which the laser beam L has been applied is reversal-developed by a minus toner. Thereby, a toner image is formed on the photosensitive drum 1.

This toner image is transferred to a recording material P fed from the sheet supplying cassette 10 and supplied to the transferring portion N by the sheet feeding roller 11, the conveying rollers 12, the registration rollers 13, etc., by the transfer roller 5. The recording material P after the transfer of the toner image is conveyed to the fixing device 14, where it is heated and pressurized, whereby the toner image is fixed on the surface of the recording material P, whereafter the recording material P is discharged onto the sheet discharging tray 15. On the other hand, the photosensitive drum 1 after the transfer of the toner image is subjected to the application of charge eliminating light by the charge eliminating device 6, whereafter any residual toner residual on the surface of the photosensitive drum 1 is scraped off by a cleaning blade 71. The residual toner thus scraped off is carried to and collected in a waste toner container (not shown) by a screw 34.

Comparison of images between a case where the above-described magnetic brush charging device was used in the image forming by the image forming apparatus (hereinafter suitably referred to as the “magnetic brush charging system”) and a case where a popular corona charging device was used in the aforementioned image forming (hereinafter suitably referred to as the “corona charging system”), that is, comparison of image flow (image deterioration), drum filming and fusion, was carried out. The following is the result of the sheet supply endurance effected under an environment of temperature 30 degrees and humidity 80%. As the cleaning blade 71, use was made of a heretofore existing urethane blade.

Corona Charging System:

Filming occurred during 250 k sheets (250,000 sheets) of image formation.

Magnetic Brush Charging System:

Some scraping-through of the toner occurred during 250 k sheets of image formation, and the amount of toner going to the back of the cleaning blade was great.

The magnetic brush charging system gently shaves the surface of the photosensitive drum and therefore, such a problem as drum fusion does not arise. On the other hand, in the corona charging system, an adhering substance occurs to the photosensitive drum 1 and it is not shaped off and therefore, during maintenance, the work of cleaning the photosensitive drum becomes necessary. On the other hand, in the magnetic brush charging system, the surface of the photosensitive drum is smoothed and therefore, the cleaning performance of the cleaning blade falls, and some of the toner scraped through and part thereof scattered in the image forming apparatus main body (the interior of the machine).

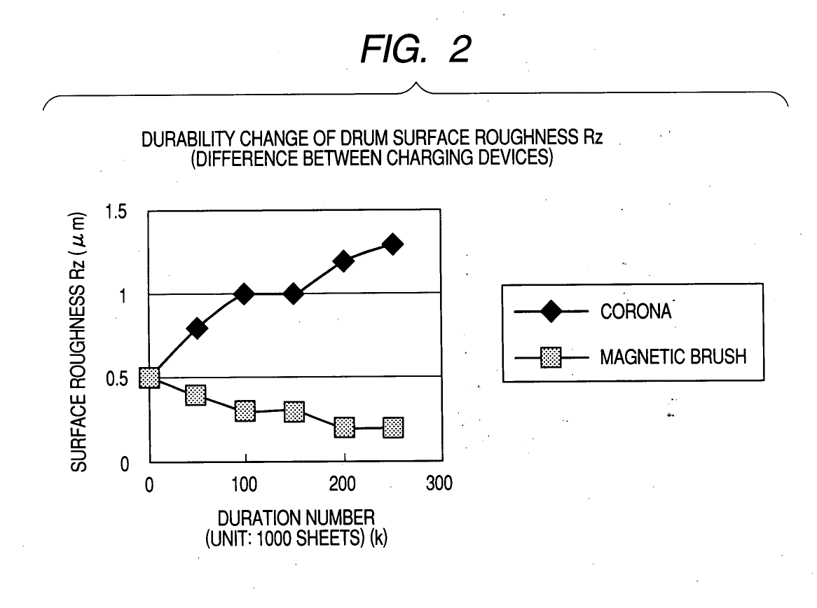

FIG. 2 shows the changes of the surface roughness of the photosensitive drum. In the corona charging system (corona), the photosensitive drum is not positively shaved and therefore, a foreign substance such as paper dust is caught by the edge portion of the cleaning blade, whereby a deep injury occurs. On the other hand, in the magnetic brush charging system (magnetic brush), even if a deep injury occurs, there is the effect of polishing the surface layer and therefore the injury is maintained shallow, and the drum surface is rather smoothed.

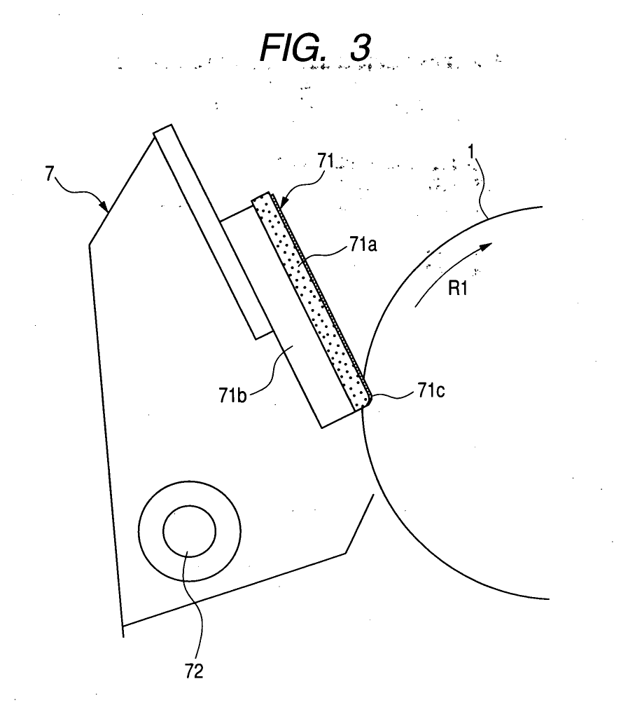

FIG. 3 shows the construction of the cleaning blade used in the present embodiment. The cleaning blade 71 shown in FIG. 3 is of two-layer structure comprising a lubricant containing portion 71a and a basic material portion 71b, and is designed to be located on a side contacting with the surface of the photosensitive drum 1. Also, the cleaning blade 71 causes the edge portion 71c of its lubricant containing portion 71a to abut against the surface of the photosensitive drum 1 in the direction of rotation thereof (a direction counter to the direction of arrow R1). This cleaning blade 71 will hereinafter be referred to as the two-layer blade.

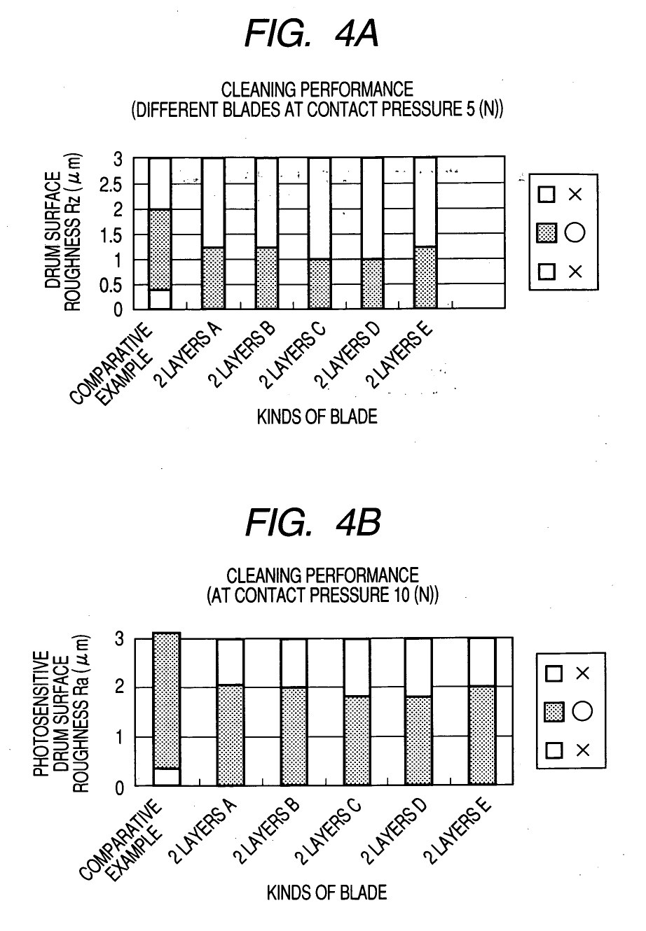

FIGS. 4A and 4B show the result of the comparison of the cleaning performance by the kinds of the cleaning blade. This experiment monitors the stained state of the cleaning blade (the amount of toner going to the back of the blade) after continuous printing of high image percentage (continuous image forming) was first effected and further, continuous printing of low image percentage was effected subsequently.

A comparative example is based on a rubber blade formed of urethane as a base material (urethane rubber blade) having impact resilience of 35% and hardness of 70 degrees.

The two-layer blade A (two layers A) is a rubber blade formed of urethane as a base material, and having 10% by weight of carbon fluoride contained in the edge portion thereof as inorganic fine particles having lubricativeness, and partly protruded to the surface thereof.

The two-layer blade B (two layers B) is a rubber blade formed of urethane as a base material, and having 10% by weight of cerium oxide contained in the edge portion thereof as inorganic particles having lubricativeness, and partly protruded to the surface thereof.

The two-layer blade C (two layers C) is a rubber blade formed of urethane as a base material, and having 15% by weight of titanium oxide contained in the edge portion thereof as inorganic particles having lubricativeness, and partly protruded to the surface thereof.

The two-layer blade D (two layers D) is a rubber blade formed of urethane as a base material, and having 10% by weight of silica contained in the edge portion thereof as inorganic particles having lubricativeness, and partly protruded to the surface thereof.

The two-layer blade E (two layers E) is a rubber blade formed of urethane s a base material, and having 8% by weight of “tospearl” contained in the edge portion thereof as inorganic particles having lubricativeness, and partly protruded to the surface thereof.

FIGS. 4A and 4B show the cleaning performance of the urethane rubber blade (comparative example) and the two-layer blades (two layers A to E) to the surface roughness of the photosensitive drum. That is, these figures show the differences in the surface roughness (drum surface roughness) Rz of the photosensitive drum 1 by the blade differences in the cleaning blade 71. FIG. 4A shows a case where the contact pressure is 5 N, and FIG. 4B shows a case where the contact pressure is 10 N.

As can be seen from FIGS. 4A and 4B, the urethane rubber blades have greater elasticity and therefore, are good in the property of following the surface shape of the photosensitive drum 1, and can sufficiently clean the toner even if the photosensitive drum 1 has a deep injury.

However, within a small range of surface roughness, the lubricant near the edge portion of the cleaning blade 71 dries up and therefore, the frictional force between the cleaning blade 71 and the surface of the photosensitive drum 1 becomes great and the edge portion begins to chatter, and the toner comes to scrape through. On the other hand, as regards the two-layer blades, when the surface of the photo-sensitive drum is roughened, the edge portion cannot follow the surface shape of the photosensitive drum and the cleaning performance thereof is not always good, but yet in a state in which the surface of the photosensitive drum 1 is smooth, even if the lubricant in the edge portion dries up, it becomes possible to perform the photosensitive drum 1 owing to the low friction of the blade itself.

Also, as shown in FIGS. 4A and 4B, the contact pressure of the cleaning blade is increased from 5 N to 10 N, whereby the property of the blade following the surface shape of the photosensitive drum becomes good and therefore, good cleaning performance can be kept even when the photosensitive drum 1 is more roughened.

However, the method of increasing the contact pressure is not a desirable method because the injury of the photo-sensitive drum by a foreign substance having entered the edge portion, and the abrasion or breakage of the edge portion of the blade are expedited.

As described above, according to the present embodiment, the magnetic brush charging device having the smoothing action and the two-layer blade of the cleaning apparatus are used in combination, whereby the deterioration of the cleaning performance which occurred in the conventional urethane rubber blade during 250 k sheets of image formation could be prevented, and good cleaning performance could be maintained during 250 k sheets of image formation. In the two-layer blade, inorganic fine particles having the lubricating action can be contained in at least the edge portion 71c.

### Second Embodiment

This embodiment differs in the construction of the edge portion of the cleaning blade from the first embodiment. In the other points, the construction of this embodiment is the same as that of the first embodiment.

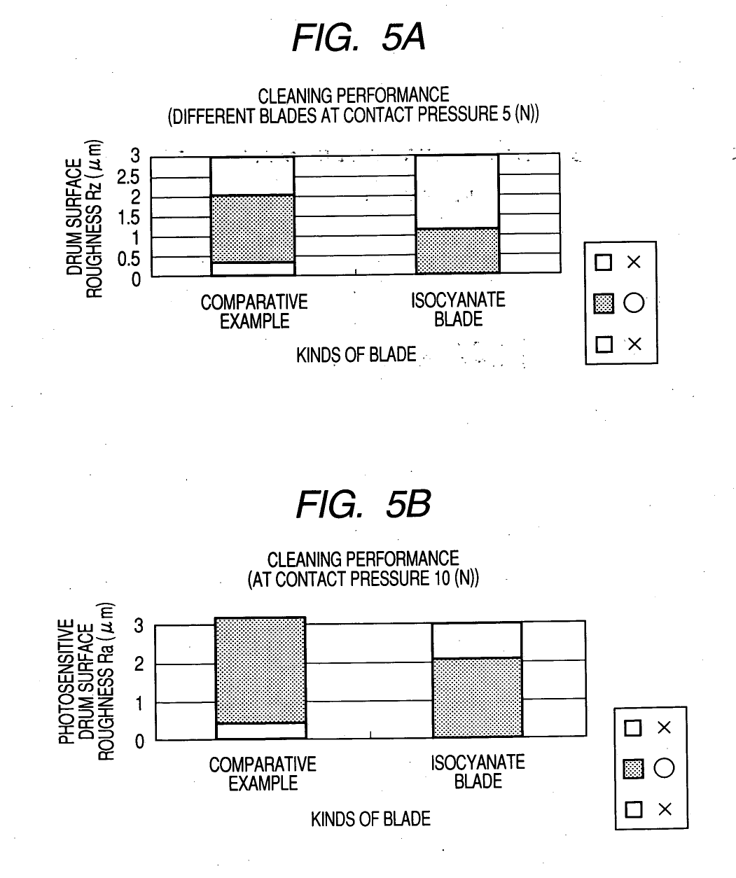

FIGS. 5A and 5B show the differences in the cleaning performance by the kinds of the cleaning blade. The present experiment monitors the stained state (the amount of toner going to the back of the blade) of the edge of the cleaning blade after continuous printing of high image percentage (continuous image forming) has first been performed, and further, continuous printing of low image percentage has been performed.

The comparative example is a rubber blade formed of urethane as a base material (urethane rubber blade) having impact resilience of 35% and hardness of 70 degrees.

In the construction shown in FIG. 3, the cleaning blade 71 used in the present embodiment has its surface adjacent to the photosensitive drum 1 which includes an edge portion 71c abutting against the photosensitive drum 1 surface-treated by an isocyanate compound to thereby form a hardened layer. This surface treatment may be effected on only the vicinity of the edge portion 71c, instead of the entire surface adjacent to the photosensitive drum 1. In the following, description will be made of a case where a hardness layer (treated portion) 71d is provided near the edge portion 71c.

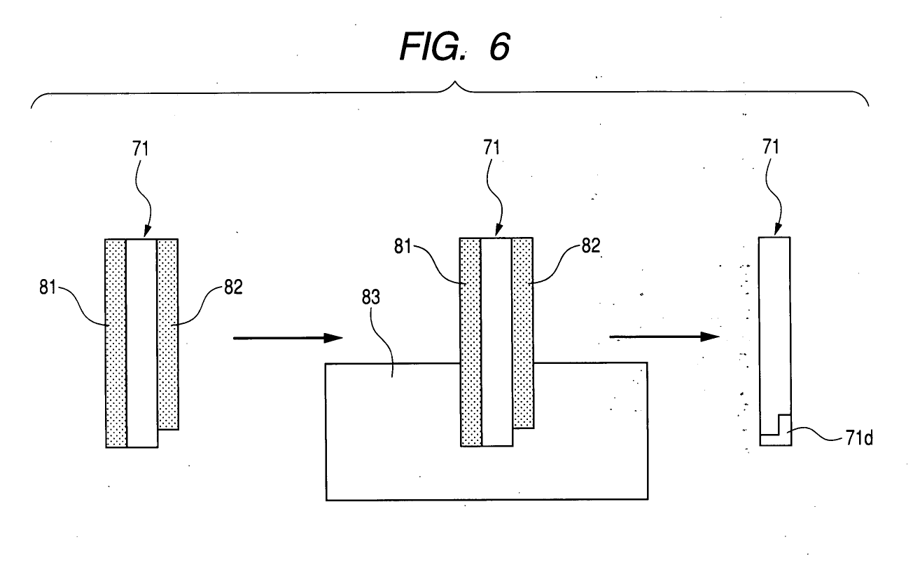

In the present embodiment, the cleaning blade 71 made of urethane was masked by chemical resistant tapes 81 and 82, as shown in FIG. 6. A solution 83 having potassium octylate diluted to 10 times at a weight ratio in terms of MEK was mixed with 4,4′-diphenyl methane diisocyanate (MDI) of 60° C., and the mixture was adjusted to catalyst density of 100 ppm, and immediately the above-mentioned masked cleaning blade 71 was immersed at 60° C. for 10 minutes, and excess isoyanate was wiped off and the masking was removed, and the cleaning blade was cured in an oven of 130° C. for 10 minutes.

FIGS. 5A and 5B show the cleaning performance of the urethane rubber blade and the cleaning blade hardened by isocyanate for the surface roughness of the photosensitive drum 1. the urethane rubber blade has more elasticity and therefore is better in the property of following the surface shape of the photosensitive drum, and can sufficiently clean the toner even if the surface of the photosensitive drum ahs a deep injury.

However, within a small range of surface roughness, the lubricant near the edge dries up and therefore, the frictional force between the cleaning blade and the surface of the photosensitive drum becomes great, and the edge portion begins to chatter and the toner comes to scrape through. On the other hand, as regards the isocyanated blade, when the surface of the photosensitive drum is roughened, the edge portion cannot follow the surface shape of the photosensitive drum and is severe in the cleaning performance, but in a state in which the photosensitive drum is smooth, this cleaning blade can sufficiently clean by the low friction of the cleaning blade itself even if the lubricant in the edge portion dries up.

Also, as shown in FIGS. 5A and 5B, the contact pressure of the cleaning blade is increased from 5N to 10N, whereby the property of the cleaning blade following the surface shape of the photosensitive drum becomes good and therefore, good cleaning performance can be kept even when the surface of the photosensitive drum is more roughened.

However, the method of increasing the contact pressure is not a desirable method because the injury of the photosensitive drum by a foreign substance having entered the edge portion, and the abrasion or breakage of the edge portion are expedited.

By using a combination of the magnetic brush discharging device having the smoothing action and the isocyanated blade which is the construction of the present embodiment, it was possible to suppress the deterioration of the cleaning performance which occurred in the urethane rubber blade after endurance, and no problem arose during 250 k sheets of image formation.

The cleaning blade in the present embodiment is characterized in that the whole or part of the cleaning blade is impregnated with an isocyanate compound and cured to thereby form hardened film from the surface toward the interior of urethane. The isocyanate compound is not restricted to the one used in the present embodiment, but use can be made of an isocyanate compound having one or more isocyanate groups in a molecule and having an isocyanate group, i.e., aliphatic monoisocyanate such as octadecylisoyanate, or aromatic monoisocyanate.

Further, as an isocyanate compound having two isocyanate groups, use is made of 2,4-tolilenedisocyanate, 2,6-tolilediisocyanate, m-phenylene-diisocyanate, tetramethylenediisocyanate, hexamethylenediisocyanate, 4,4′,4″-triphenylmethanetriisocyanate, 2,4′,4″-biphenyltriisocyanate, 2,4,4″-diphenylmethanetriisocyanate or the like. Particularly these are not restrictive. Also, use can be made of the denatured body and polymer of an isocyanate compound having three or more isocyanate groups and an osocyanate compound having two or more isocyanate groups.

Among these, aliphatic monoisocyanate having little steric hindrance, and as in the present embodiment, m-phenylenediisocyanate (MDI) or the like having small molecular weight are preferable from the viewpoint of permeability.

However, whatever isocyanate compound may be used, it is coupled to the urethane molecules of the base material to thereby form a hardened layer, and comes to provide low friction, and by being combined with an image forming apparatus of the magnetic brush charging type, an improvement in cleaning performance similar to that in the present embodiment is obtained.

In the above-described first and second embodiments, description has been made of an example in which an a-Si photosensitive drum is used as the image bearing member, but alternatively, as the image bearing member, use may be made, for example, of an organic photosensitive member having on an aluminum cylinder a charge generation layer having a disazo pigment dispersed in resin and a charge transport layer having hydrazone dispersed in polycarbonate resin, and further having on the outermost layer an organic photosensitive layer comprising a charge injection layer having super-fine particles of SnO₂ dispersed in acryl resin hardenable by light, an ultraviolet ray or an electron beam. When this is used, a similar effect can also be achieved.

In the construction of each of the embodiments described above, the image bearing member tends to be smoothed by the rubbing of the electrically conductive particles and therefore, the amount of lubricants such as the toner and the additive which have entered the uneven portions of the surface of the image bearing member becomes small and the frictional force between the cleaning blade and the image bearing member tends to become high, but by reducing the coefficient of friction of the edge portion of the cleaning blade, it is possible to prevent a problem such as the turning-up of the blade. That is, use can be made of a charging method using the rubbing of electrically conductive fine particles and therefore, there can be provided an image forming apparatus which can satisfy both of two functions, i.e., an improvement in the uniformity of charging and an improvement in the cleaning performance.

Also, even when due to the surface of the image bearing member being smoothed as described above, the contact pressure of the cleaning blade with respect to the image bearing member is set to a low level, the property of the cleaning blade following the image bearing member can be secured well and therefore, the abrasion of the cleaning blade can be reduced.

While the first and second embodiments have been described as specific examples to which the present invention can be applied, the various constructions described in the foregoing first and second embodiments can be changed to other known construction within the scope of the idea of the present invention.

This application claims priority from Japanese Patent Application No. 2003-435690 filed on Dec. 26, 2003, which is hereby incorporated by reference herein.

1. An image forming apparatus comprising:
an image bearing member;
image forming means for forming a toner image on said image bearing member, said image forming means having charging means for charging said image bearing member by rubbing electrically conductive particles against said image bearing member; and
an elastic blade for removing residual toner on said image bearing member;
wherein an edge portion of said blade which abuts against said image bearing member is low-friction-processed.

2. An image forming apparatus according to claim 1, wherein said elastic blade has a base layer and a surface layer provided on said base layer and containing lubricative fine particles.

3. An image forming apparatus according to claim 2, wherein said lubricative fine particles are contained so as to partly protrude from said surface layer.

4. An image forming apparatus according to claim 1, wherein the edge portion of said elastic blade is surface-treated by an isocyanate compound.

5. An image forming apparatus according to claim 1, wherein said charging means injection-charges said image bearing member.

6. An image forming apparatus according to claim 1, wherein said charging means has a rotary member rotated with said electrically conductive fine particles carried thereon.

7. An image forming apparatus according to claim 6, wherein said charging means has magnetic field generating means for causing said electrically conductive fine particles to be magnetically carried on said rotary member.

8. An image forming apparatus according to claim 1, wherein said electrically conductive fine particles have a characteristic of smoothing the surface of said image bearing member.
